(19) United States
(12) Patent Application Publication
(10) Pub. No.: US 2010/0096046 A1
(43) Pub. Date: Apr. 22, 2010

(54) Method of improving formability of magnesium tubes

(75) Inventors: Paul E. Krajewski, Sterling Heights, MI (US); Ravi Verma, Shelby Township, MI (US); Jon T. Carter, Farmington, MI (US)

Correspondence Address: GENERAL MOTORS LLC;LEGAL STAFF, MAIL CODE 482-C23-B21, P O BOX 300, DETROIT, MI, 48265-3000, US

(73) Assignee: GM Global Technology Operations, Inc., Detroit, MI (US)

(21) Appl. No.: 11/554,193

(22) Filed: Oct. 30, 2006

(51) Int. Cl. C21D 8/10; B23K 31/02; B21B 27/06

(52) U.S. Cl. 148/519; 228/144; 72/200

(57) ABSTRACT

A method that improves the formability of magnesium and magnesium tubes without altering the chemistry of such material or requiring changes to formation tooling. Magnesium or magnesium alloy sheet stock is subjected to at least one cycle of roll-forming deformation in a first direction followed by a reversal of roll-forming deformation and progressive development of a substantially circular cross-section. Lateral edges of the sheet are adjoined and the structure is thereafter heated above the recrystallization temperature.

### TECHNICAL FIELD

The present invention relates generally to metal forming processes and more particularly to a method for improving the formability of magnesium and magnesium alloy tubes by grain size refinement using mechanical deformation and recrystallization.

### BACKGROUND OF THE INVENTION

Because of the increasing emphasis on reducing the weight of structural members in environments such as automobiles, aircraft and other transportation vehicles, substantial effort has been directed towards the development of parts formed from magnesium and magnesium alloys that are suited for such applications. A number of such parts are tubular in construction formed from a magnesium or magnesium alloys. These tubular structures may be shaped by techniques such as applying internal pressure in a heated mold so as to selectively expand the tube at positions as may be desired. By way of example only, and not limitation, suitable formation practices may include elevated temperature forming techniques such as hot blow forming and the like.

As will be appreciated, it may be desirable to form relatively complex shapes incorporating tight curvature radius segments. Magnesium and magnesium alloy tubes may be difficult to form into such parts due to limited formability. This limited formability may result in splits or tears during forming that prevent the desired geometry from being formed. Accordingly, it may be desirable to improve the formability of the magnesium or magnesium tubes prior to shaping. At the same time, it may be undesirable to change the basic chemistry of such materials which provides the desired strength to weight characteristics. Likewise it is generally undesirable to change features of the formation tooling due to the extreme cost.

### SUMMARY OF THE INVENTION

The present invention is believed to provide advantages and/or alternatives over prior practices by providing a method that improves the formability of magnesium and magnesium alloy tube stock without altering the chemistry of such material or requiring changes to formation tooling.

According to potentially preferred features of the instant invention, magnesium or magnesium alloy sheet stock is subjected to at least one cycle of progressive roll-forming deformation to produce a curved cross section followed by reflattening and roll forming in a reverse direction prior to completion of a circular profile. The roll forming deformation may be reversed multiple times if desired such that multiple cycles of bending in a first direction and then bending in the opposite direction are carried out. The introduction of controlled plastic deformation gives rise to the development of dislocations and twins within the metal matrix which, in turn, cause a refinement in grain size when the metal is subjected to subsequent annealing or elevated temperature formation. The application of such pre-formation working preferably facilitates the use of lower cost strip cast sheet stock without the need for intermediate rolling treatment.

### BRIEF DESCRIPTION OF THE DRAWINGS

The accompanying drawings which are incorporated in and which constitute a portion of this specification illustrate exemplary practices according to the invention which, together with the general description above and the detailed description set forth below will serve to explain the principals of the invention wherein:

FIG. 1 is a flow chart of a simplified process to improve formability of magnesium or magnesium alloy tube stock material;

FIG. 2 is a simplified schematic of a roll forming process line to impart a cycle of progressive bending in a first direction followed by bending in a second direction to develop a circular profile magnesium or magnesium alloy tube;

FIGS. 2A-2O are schematic cross-section views taken along the process line of FIG. 2 illustrating an exemplary progressive bending cycle;

FIG. 3 illustrates a seamed tube formed following a bending cycle;

FIG. 4 illustrates an exemplary elevated temperature formation procedure for a tube;

FIG. 5 illustrates a tube following elevated temperature formation.

While potentially preferred procedures and practices have been illustrated and generally described above, it is to be understood and appreciated that in no event is the invention to be limited to such embodiments and procedures as may be specifically described herein. On the contrary, it is intended that the present invention shall extend to all alternatives and modifications as may embrace the broad principals of the invention within the true spirit and scope thereof.

### DETAILED DESCRIPTION

For ease of reference and understanding, the following description is set forth with respect to a simplified exemplary process. However, it is to be understood that the process according to the present invention is in no way limited to a particular forming practice as may be illustrated and described. Rather it is intended that any number of treatment practices applying pre-formation deformation and recovery may be utilized.

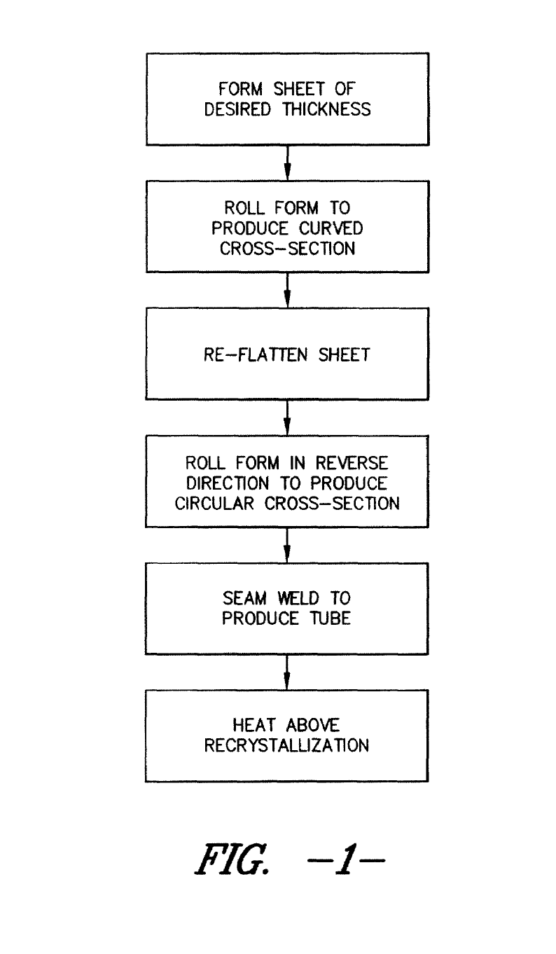

Referring to FIG. 1, a simplified treatment process for enhancing the formability of a magnesium or magnesium alloy tubes is provided. As shown, according to this practice, a sheet of such material is first formed in a desired thickness. This initial formation may be carried out by any suitable practice as may be typically use by those of skill in the art including casting, hot rolling an ingot or the like. According to one potentially preferred practice, the starting sheet material may be a strip cast material substantially free from prior rolling treatment. Of course, previously rolled sheet materials may likewise be utilized if desired.

Following initial formation, the sheet of magnesium or magnesium alloy is thereafter subject to a roll forming process wherein the sheet is gradually formed into a curved, generally trough-shaped, cross-sectional geometry. Thereafter, the curved cross-section is substantially reflattened and curved in a reverse direction by roll forming. This process may be reversed and repeated multiple times if desired. After a desired number of roll forming bending cycles has been completed, the roll forming is carried out in a given direction to a degree such that a substantially circular cross-section is developed. Thereafter, an appropriate joining procedure such as seam welding or the like is used to join the free edges together and form a tube. The tube is thereafter heated above the recrystallization temperature as will be described further hereinafter.

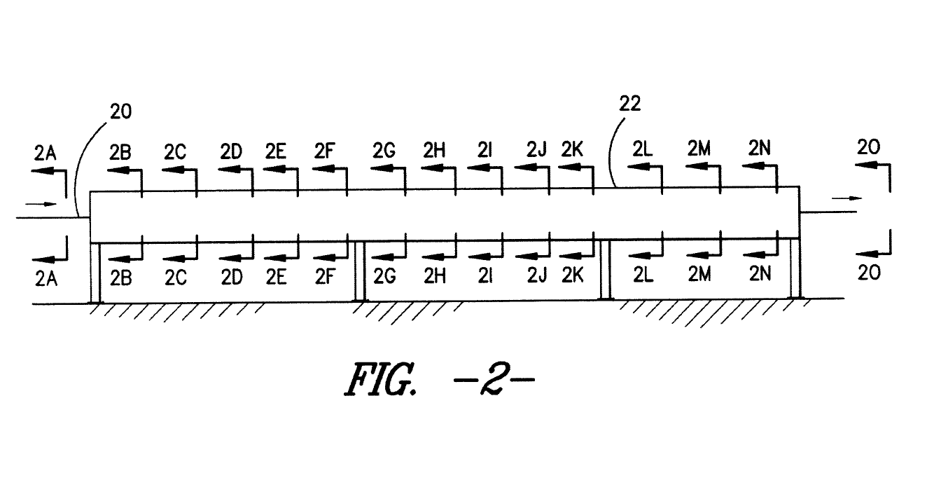

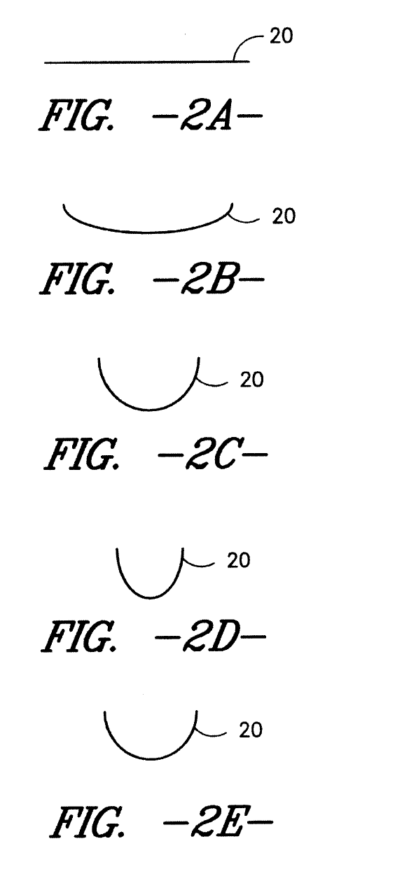

Referring to FIG. 2, an exemplary processing line is illustrated for applying and reversing curvature according to one complete cycle so as to develop a tubular cross section. As shown, according to the exemplary process a preformed sheet 20 having a substantially planar cross-section (FIG. 2A) and predefined thickness enters a roll former 22. As will be well understood by those of skill in the art, a roll former uses an arrangement of force applying rolls to progressively contour the shape of an article. The roll-forming process may be substantially continuous or may be carried out as a series of substantially discrete steps.

By way of example only, and not limitation, FIGS. 2B-2O illustrate a contemplated and potentially desired progression of cross-sectional geometries developed as the plate 20 moves through the roll-forming process. As will be appreciated, each of these geometries corresponds generally to the geometry present at the defined position along the roll-forming process 22.

As illustrated, the sheet undergoes a gradual bending from the substantially flat planar configuration illustrated in FIG. 2A to a substantially semi-circular cross-sectional profile as illustrated in FIG. 2D. During bending the radius of curvature is preferably substantially uniform between the lateral edges of the sheet 20 so that each portion of the plate experiences substantially uniform deformation. Once a substantially semi-circular cross-sectional profile has been achieved, the roll-forming process may thereafter be reversed to progressively contour the sheet 20 back towards its original planar configuration. The bending procedure is thereafter preferably reversed with the bending taking place in the opposite direction. That is, in the event that the initial bending operation produced a generally convex profile, the subsequent bending operation preferably develops a generally concave profile. The roll forming may be continued without interruption until a substantially circular cross section is developed or the process may be reversed at an intermediate stage and repeated one or more times as may be desired. Eventually, the roll forming proceeds to a stage at which a substantially circular cross section is developed. Of course, the process may be carried out numerous times if desired.

During the roll forming operation the sheet 20 is preferably maintained at a temperature of about 25 degrees Celsius to about 200 degrees Celsius. Such a temperature is believed to facilitate the efficiency of the roll-forming process while nonetheless being below the temperature that provides substantial recrystallization of the magnesium or magnesium alloy.

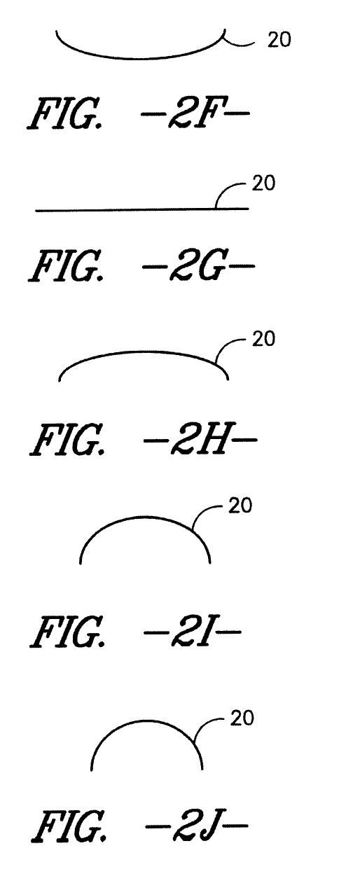

Referring back to FIG. 1, once the roll forming procedure has been completed, the resultant tube form is thereafter preferably seam welded at least partially along its length to form a tube 30 (FIG. 3) and then subjected to an elevated temperature in the range of at least 300 degrees Celsius and, most preferably, about 300 to about 500 degrees Celsius so as to promote recrystallization. The sheet is then subjected to elevated temperature forming techniques such as hot blow forming, bending and the like. The introduction of elevated temperature to promote recrystallization may be carried out as part of this elevated temperature formation process if desired.

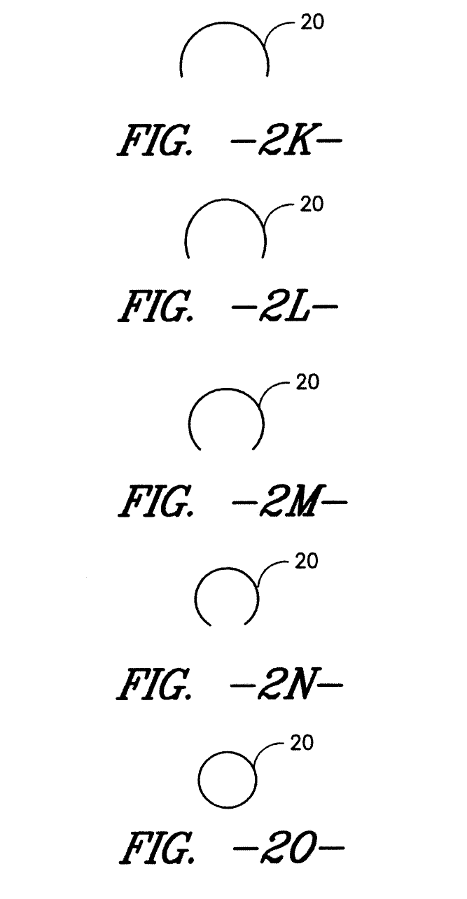

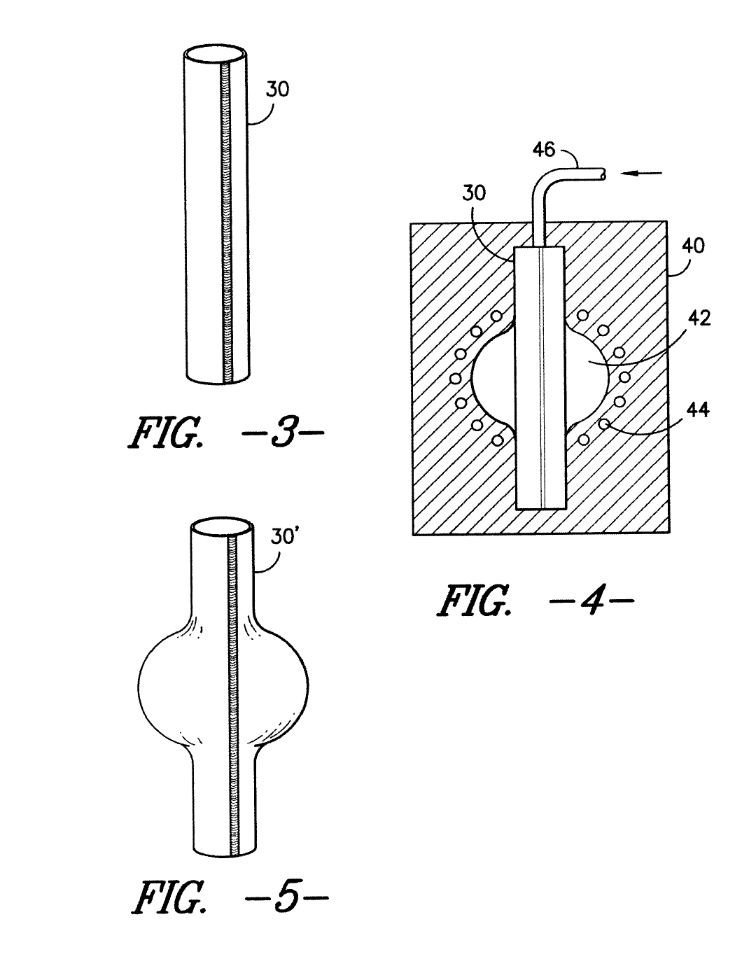

By way of example only, and not limitation, an exemplary elevated formation process is illustrated in FIG. 4. As shown, in this exemplary procedure the tube 30 is placed in a mold 40 having a cavity 42 of predefined shape. While the illustrated cavity 42 is generally spherical in shape, it is to be appreciated that the cavity 42 may have virtually any shape as may be desired. The tube 30 within the mold 40 is preferably heated such as by the use of induction coils 44 or the like. Upon the achievement of a desired temperature, a pressurizing medium such as argon, nitrogen or other gas may be introduced through a conduit 46 to the interior of the tube 30. The internal pressure thus causes the tube 30 to plastically deform so as to substantially adopt the configuration of the cavity 42 thereby yielding a formed tube 30′ (FIG. 5). If desired, the formed tube 30′ may thereafter undergo an annealing treatment.

Without being limited to a particular theory, it is believed that the progressive cyclical bending of the sheet 20 has the effect of introducing atomic level dislocations and so-called twins within the metal lattice structure. Such dislocations and twins tend to reduce the grain size when the sheet is subjected to recrystallization temperatures. This grain size refinement is believed to promote more uniform performance across the material when high temperature forming processes are applied thereby enhancing formability during the forming process.

It is to be understood that while the present invention has been illustrated and described in relation to potentially preferred procedures, that such procedures are illustrative only and that the invention is in no way limited thereto. Rather, it is contemplated that modifications and variations embodying the principals of the invention will no doubt occur to those of skill in the art. It is therefore contemplated and intended that the invention shall extend to all such modifications and variations as may incorporate the broad aspects of the invention within the true spirit and scope thereof.

1. A method for improving formability of magnesium and magnesium alloy tubes, the method comprising the steps of:
(a) providing a substantially planar sheet of magnesium or magnesium alloy having a substantially uniform thickness;
(b) roll-forming the sheet at a temperature below the recrystallization temperature of the sheet to develop a first arcuate cross sectional profile between lateral edges of the sheet so that the sheet has a single arc profile;
(c) roll-forming the sheet at a temperature below the recrystallization temperature of the sheet following step (b) to substantially reverse the cross sectional profile developed in step (b) such that a second arcuate cross sectional profile between lateral edges of the sheet is developed, wherein the second arcuate cross sectional profile is characterized by reverse concavity from the first arcuate cross sectional profile;
(d) following steps (b) and (c), roll forming the sheet at a temperature below the recrystallization temperature of the sheet to develop a substantially circular cross sectional profile;
(e) adjoining the lateral edges of the sheet together to form a tube; and
(f) heating the tube above the recrystallization temperature of the sheet following step (e).

2. The method as recited in claim 1, wherein the first arcuate cross sectional profile is characterized by a substantially uniform radius of curvature between the lateral edges of the sheet.

3. The method as recited in claim 2, wherein the first arcuate cross sectional profile is substantially semi-circular.

4. The method as recited in claim 1, wherein each of steps (b), (c) and (d) is carried out at a temperature of about 25 to about 200 degrees Celsius.

5. The method as recited in claim 1, wherein the substantially planar sheet of magnesium or magnesium alloy is a strip cast sheet.

6. A method for improving formability of magnesium and magnesium alloy tubes, the method comprising the steps of:
(a) providing a substantially planar sheet of magnesium or magnesium alloy having a substantially uniform thickness;
(b) roll-forming the sheet at a temperature below the recrystallization temperature of the sheet to develop a first arcuate cross sectional profile between lateral edges of the sheet so that the sheet has essentially a single arc profile;
(c) roll-forming the sheet at a temperature below the recrystallization temperature of the sheet following step (b) to substantially reverse the cross sectional profile developed in step (b) and to progressively develop a substantially circular cross sectional profile;
(d) adjoining the lateral edges of the sheet together to form a tube; and
(e) plastically deforming the tube at a temperature above the recrystallization temperature of the sheet.

7. The method as recited in claim 6, wherein the first arcuate cross sectional profile is characterized by a substantially uniform radius of curvature between the lateral edges of the sheet.

8. The method as recited in claim 7, wherein the first arcuate cross sectional profile is substantially semi-circular.

9. The method as recited in claim 6, wherein step (b) is carried out at a temperature of about 25 to about 200 degrees Celsius.

10. The method as recited in claim 9, wherein step (c) is carried out at a temperature of about 25 to about 200 degrees Celsius.

11. The method as recited in claim 10, wherein the adjoining step comprises seam welding.

12. The method as recited in claim 6, wherein the substantially planar sheet of magnesium or magnesium alloy is a strip cast sheet.

13. A method for improving formability of magnesium and magnesium alloy tubes, the method comprising the steps of:
(a) providing a substantially planar sheet of magnesium or magnesium alloy having a substantially uniform thickness;
(b) roll-forming the sheet at a temperature of about 25 to about 200 degrees Celsius to develop a first arcuate cross sectional profile characterized by a substantially uniform radius of curvature between lateral edges of the sheet so that the sheet has a single arc profile;
(c) roll-forming the sheet at a temperature of about 25 to about 200 degrees Celsius following step (b) to substantially reverse the cross sectional profile developed in step (b) and to progressively develop a substantially circular cross sectional profile;
(d) seam welding the lateral edges of the sheet together to form a tube; and
(e) heating the tube to a temperature above the recrystallization temperature of the sheet.

14. The method as recited in claim 13, wherein the first arcuate cross sectional profile is substantially semi-circular.

15. The method as recited in claim 13 wherein step (c) is carried out in a substantially continuous non-reversing progressive operation.

16. The method as recited in claim 13, wherein the heating step is carried out in conjunction with elevated temperature deformation.

17. The method as recited in claim 13, wherein the substantially planar sheet of magnesium or magnesium alloy is a strip cast sheet.
